(19) United States
(12) Patent Application Publication
(10) Pub. No.: US 2012/0156116 A1
(43) Pub. Date: Jun. 21, 2012

(54) Process For Metal Recovery From Catalyst Waste

(75) Inventors: Xingtao Gao, Holmdel, NJ (US); William Todd Owens, Tallahassee, FL (US)

(73) Assignee: BASF Corporation, Florham Park, NJ (US)

(21) Appl. No.: 12/968,333

(22) Filed: Dec. 15, 2010

(51) Int. Cl. C01F 17/00; C22B 1/00; C07F 19/00

(52) U.S. Cl. 423/21.1; 534/15; 534/16; 75/401

(57) ABSTRACT

A method for recovering rare earth metals from zeolite-containing waste FCC catalysts comprises an acid leaching step to remove the rare earth metals from the catalyst to form a leachate containing dissolved rare earth metals and separating the rare earth metals from the leachate such as by precipitation.

### FIELD OF THE INVENTION

The present invention relates to a process for recovering metals from metal-containing catalyst waste. The invention is particularly useful in recovering rare earth metals from waste FCC equilibrium zeolite catalysts.

### BACKGROUND OF THE INVENTION

Catalytic cracking is a petroleum refining process that is applied commercially on a very large scale. About 50% of the refinery gasoline blending pool in the United States is produced by this process, with almost all being produced using the fluid catalytic cracking (FCC) process. In the FCC process, heavy hydrocarbon fractions are converted into lighter products by reactions taking place at high temperatures in the presence of a catalyst, with the majority of the conversion or cracking occurring in the gas phase. The FCC hydrocarbon feedstock (feedstock) is thereby converted into gasoline and other liquid cracking products as well as lighter gaseous cracking products of four or fewer carbon atoms per molecule. These products, liquid and gas, consist of saturated and unsaturated hydrocarbons.

In FCC processes, feedstock is injected into the riser section of a FCC reactor, where the feedstock is cracked into lighter, more valuable products upon contacting hot catalyst circulated to the riser-reactor from a catalyst regenerator. As the endothermic cracking reactions take place, carbon is deposited onto the catalyst. This carbon, known as coke, reduces the activity of the catalyst and the catalyst must be regenerated to revive its activity. The catalyst and hydrocarbon vapors are carried up the riser to the disengagement section of the FCC reactor, where they are separated. Subsequently, the catalyst flows into a stripping section, where the hydrocarbon vapors entrained with the catalyst are stripped by steam injection. Following removal of occluded hydrocarbons from the spent cracking catalyst, the stripped catalyst flows through a spent catalyst standpipe and into a catalyst regenerator.

Typically, catalyst is regenerated by introducing air into the regenerator and burning off the coke to restore catalyst activity. These coke combustion reactions are highly exothermic and as a result, heat the catalyst. The hot, reactivated catalyst flows through the regenerated catalyst standpipe back to the riser to complete the catalyst cycle. The coke combustion exhaust gas stream rises to the top of the regenerator and leaves the regenerator through the regenerator flue. The exhaust gas generally contains nitrogen oxides (NOx), sulfur oxides (SOx), carbon monoxide (CO), oxygen (O₂), HCN or ammonia, nitrogen and carbon dioxide (CO₂).

The three characteristic steps of the FCC process that the cracking catalyst undergoes can therefore be distinguished: 1) a cracking step in which feedstock is converted into lighter products, 2) a stripping step to remove hydrocarbons adsorbed on the catalyst, and 3) a regeneration step to burn off coke deposited on the catalyst. The regenerated catalyst is then reused in the cracking step.

A major breakthrough in FCC catalysts came in the early 1960's, with the introduction of molecular sieves or zeolites. These materials were incorporated into the matrix of amorphous and/or amorphous/kaolin materials constituting the FCC catalysts of that time. These new zeolitic catalysts, containing a crystalline aluminosilicate zeolite in an amorphous or amorphous/kaolin matrix of silica, alumina, silica-alumina, kaolin, clay or the like were at least 1,000-10,000 times more active for cracking hydrocarbons than the earlier amorphous or amorphous/kaolin containing silica-alumina catalysts. This introduction of zeolitic cracking catalysts revolutionized the fluid catalytic cracking process. New processes were developed to handle these high activities, such as riser cracking, shortened contact times, new regeneration processes, new improved zeolitic catalyst developments, and the like. The new catalyst developments revolved around the development of various zeolites such as synthetic types X and Y and naturally occurring faujasites.

It is well known in the art that to obtain good cracking activity the zeolites have to be in a proper form. In most cases this involves reducing the alkali metal content of the zeolite to as low a level as possible. Further, a high alkali metal content reduces the thermal structural stability, and the effective lifetime of the catalyst will be impaired as a consequence thereof. Procedures for removing alkali metals and putting the zeolite in the proper form are well known in the art. Specifically, in order to modify the properties of zeolites, the original cations of the aluminosilicates, usually sodium, potassium, and/or calcium, are changed by processes of ion-exchange. Ion-exchange of the original ions has been found to have an especially beneficial effect on the catalytic cracking and thermal stability properties of the crystalline aluminosilicates.

Typically, the aluminosilicate materials may be converted to the H or acid form in which hydrogen ions occupy the cation sites. For example, such a conversion may be had by ion-exchange with an ammonium ion followed by heating to drive off NH₃ or by controlled acid leaching with a hydrochloric acid solution or like reagent. In general, the H form is more stable in materials having SiO₂/Al₂O₃ of 3.5 or higher. Useful catalysts are also produced by a combination of ion-exchange treatments. For example, the crystalline aluminosilicates may be converted to the H or acid form by acid leaching and then may be ion-exchanged with a solution of rare earth salts to produce catalysts such as rare earth-hydrogen exchanged mordenite, rare earth-hydrogen exchanged synthetic faujasite of X or Y type and many other useful ion-exchanged catalysts. It will also be apparent that more than one type of metal cation may be used to ion-exchange the crystalline aluminosilicates and that the sequence of ion-exchange treatments may be varied. For example, acid leaching to substitute hydrogen ions may precede or follow ion-exchange treatment to substitute metal cations.

It has been found particularly useful to improve the activity of the catalyst to include rare earth cations such as cerium, lanthanum and mixtures thereof into the zeolite molecular sieve. Other rare earths, including praseodymium, neodymium, etc. have also been used along with cerium and lanthanum, to not only improve the activity of the zeolite catalyst, but to improve the thermostability of the catalyst and to also reduce the emissions of NOx in the regenerator flue gas. Typically, the zeolite catalyst is ion exchanged to achieve about 1-25 wt. % of the rare earth based on rare earth oxide. Levels of rare earth based on the oxides thereof (REO) from 4-12 wt. %, have been found particularly useful.

After enduring numerous cycles of cracking, stripping and regeneration, the FCC zeolite catalyst will have reduced activity due to the loss of the crystal structure of the zeolite. Accordingly, the FCC catalyst must be periodically removed from the cracking system and replaced with fresh catalyst. Each year, the FCC units around the world generate millions of pounds of spent FCC catalysts known as “equilibrium catalysts” (Ecats) for landfill. The typical waste catalyst can often contain rare earth oxide contents of at least 0.5 wt. %, and a zeolite content of at least about 5 wt. %.

Recently, the ability to obtain rare earth metals has been greatly reduced, due at least in part to the difficulty in obtaining the rare earth materials by mining and purification techniques which would not be hazardous to the environment. Thus, many suppliers of rare earth metals have stopped mining activities due to the high costs of mining and recovering the rare earth metals without harming the surrounding environment. Accordingly, the supply of rare earth metals is being concentrated in a few countries, including China, which due to its growing economic activity, does not find it economical to readily export the rare earth metals, but instead, use such metals for domestic consumption. Recent concerns regarding the shortage of supply of rare earth metals has made the news worldwide. Accordingly, to simply discard the waste zeolite catalyst, especially when such catalyst may contain significant amounts of rare earth metals, does not make economic sense.

The regeneration and recycle of Ecats have been attempted by many researchers. U.S. Pat. No. 5,182,243 discloses a process for the reuse and recycling of FCC Ecats by treating an Ecat with necessary chemicals and ingredients to re-grow zeolite Y in the pores of the matrix of FCC microspheres. U.S. Pat. No. 4,686,197 discloses processes that demetallate a catalyst contaminated with at least one contaminant metal such as vanadium, nickel, iron, etc. and re-use of the demetallated Ecats. Although some activity has been recovered by these two processes, the regenerated and recycled catalysts still perform well below the fresh catalysts.

Acid leaching is well known in the art for obtaining rare earths from rare earth ores. CN 1043685 teaches a method of leaching rare earth from rare earth-containing ores using 0.1-0.2 N sulfuric acid. The leachate is further treated with ammonia to pH of 5.0-5.1 (for heavy rare earth-type ores) or 5.68-5.83 (for light rare earth-type ores) to precipitate Al and Fe impurities that are then removed by filtration. Additional NH₃ is added to the Al and Fe-free leachate to precipitate heavy rare earths as hydroxides at pH 7.0-7.2 and light rare earths at pH 8.5-9.5. Another patent RU 41511 also teaches a similar method to obtain rare earth compounds from lovchorrite. In this process, after acid leaching, Ti compounds are precipitated and separated from the acid leaching solution at pH 4.4 by NH₄OH, followed by precipitation and separation of Fe and Al at pH 6-6.2. The impurity-free solution is finally treated with NH₄OH to obtain rare earth compounds.

Various processes have been patented for rare earth recovery from specific and different wastes. WO 96/00698 discloses a process for recovery of rare earth, in particular Nd, from metal alloy wastes (massive Fe metal) involving steps of oxidizing the metal alloy and partially dissolving REO with mineral acid and further processing of dissolved rare earth in solution to rare earth oxide (Nd₂O₃). A similar patent (U.S. Pat. No. 5,961,938) discusses a method for recovery of rare earth and cobalt from rare earth-Fe metal alloy waste generated from magnet manufacturing. Both air and nitric acid are used for selectively dissolving rare earth and Co from the metal alloy. The resulting solution is further processed to obtain rare earth fluorides, or oxalates.

Another patent (U.S. Pat. No. 3,420,860) discloses a method of recovering rare earth from orthovanadate compound LnVO₄ phosphors that are manufacturing wastes in the color television industry. The rare earth in LnVO₄ is dissolved in nitric acid or HCl while vanadium pentoxide is filtered out. The rare earth containing solution is further processed to obtain rare earth oxalates.

U.S. Pat. No. 5,180,563 discloses a process for treating waste sludges generated during processing of metal bearing ores, such as tungsten ores. The patent is concerned with recovering different metals values from the wastes, such as tungsten, iron, manganese, scandium, possibly other metals such as tantalum, niobium, rare earth etc. Rare earth and scandium, chromium as minor components of metal values may be obtained by leaching the waste sludge with a mixture of sulfuric acid and hydrogen peroxide and separating from metal components such as Fe and Mn by pH adjustment in the leaching solution.

WO 03/104149 discloses a process of recovering REO from polishing liquid waste for re-use as an abrasive. The process comprises several steps of (1) treating the waste liquid with an acid under reflux/bubbling conditions; (2) removal of insoluble matter; (3) processing rare earth containing solution to obtain rare earth carbonates or oxalates and further converting to rare earth oxides.

Each of the above patents disclosing a rare earth recovery process is unique and specifically directed to the treatment of a specific waste. The current invention concerns specifically FCC industrial wastes such as Ecat and FCC catalyst manufacturing wastes that contain at least 5% zeolite, and alumina and silica as major components.

Thus, it is an objective of the present invention to provide a process for the recovery of rare earth metals from waste zeolite-containing FCC catalysts which contain rare earth oxides.

### SUMMARY OF THE INVENTION

The present invention is directed to recovering rare earth metals from zeolite-containing wastes, such as FCC equilibrium catalyst or FCC catalyst manufacturing wastes. The recovery process, in general, comprises an acid leaching step and a step for separating the leached rare earth metals from impurities.

### DETAILED DESCRIPTION OF THE INVENTION

Catalyst compositions which may be treated to recover rare earth metals by the procedures of this invention include cracking catalysts, which comprise a rare earth metal supported on a zeolite base having an ion exchange capacity of at least about 0.01 meq/gm, and preferably at least about 0.1 meq/gm. Suitable zeolite bases include for example the crystalline aluminosilicate molecular sieves such as the Y, (including ultrastable Y) X, A, L, T, ZSM, and B crystal types, as well as zeolites found in nature such as for example mordenite, stilbite, heulandite, ferrierite, dachiardite, chabazite, erionite, offretite, and the like. Typical crystalline zeolites useful for FCC cracking of hydrocarbon feedstocks are those having crystal pore diameters between about 6-15 A, wherein the SiO₂/Al₂O₃ mole ratio is at least about 3/1. The term “zeolites” as used herein contemplates not only aluminosilicates, but also substances in which the aluminum is replaced by gallium or boron and substances in which the silicon is replaced by germanium. For most FCC catalytic purposes, it is preferable to replace most or all of the zeolitic alkali metal cations normally associated with such zeolites with other cations, particularly hydrogen ions and often with rare earth metal ions such as cerium, lanthanum, praseodymium, neodymium and the like, for reasons discussed above.

The rare earth metal component is ordinarily added to the zeolite base by ion exchange with an aqueous solution of a suitable compound of the desired metal wherein the metal is present in a cationic form, as is well known. Suitable amounts may range between about 1 percent and 25 percent by weight, typically 3 to 12 percent by weight, based on rare earth oxide (REO).

The REO-exchanged zeolite can be incorporated into a matrix. Suitable matrix materials include the naturally occurring clays, such as kaolin, halloysite and montmorillonite and inorganic oxide gels comprising amorphous catalytic inorganic oxides such as silica, silica-alumina, silica-zirconia, silica-magnesia, alumina-boria, alumina-titania, and the like, and mixtures thereof. Preferably the inorganic oxide gel is a silica-containing gel, more preferably the inorganic oxide gel is an amorphous silica-alumina component, such as a conventional silica-alumina cracking catalyst, several types and compositions of which are commercially available. These materials are generally prepared as a co-gel of silica and alumina, co-precipitated silica-alumina, or as alumina precipitated on a pre-formed and pre-aged hydrogel. In general, silica is present as the major component in the catalytic solids present in such gels, being present in amounts ranging between about 55 and 100 weight percent. Most often however, active commercial FCC catalyst matrix are derived from pseudo-boehmites, boehmites, and granular hydrated or rehydrateable aluminas such as bayerite, gibbsite and flash calcined gibbsite, and bound with peptizable pseudoboehmite and/or colloidal silica, or with aluminum chlorohydrol. The matrix component may suitably be present in the catalyst in an amount ranging from about 25 to about 92 weight percent, preferably from about 30 to about 80 weight percent of the FCC catalyst.

As an alternative to incorporating the zeolite in a matrix, Engelhard Corporation has developed a process of forming a zeolite in-situ within a matrix such as formed from kaolin.

U.S. Pat. No. 4,493,902, the teachings of which are incorporated herein by cross-reference is a basic example of such in-situ zeolite formation, and discloses novel fluid cracking catalysts comprising attrition-resistant, high zeolitic content, catalytically active microspheres containing more than about 40%, preferably 50-70% by weight Y faujasite and methods for making such catalysts by crystallizing more than about 40% sodium Y zeolite in porous microspheres composed of a mixture of two different forms of chemically reactive calcined clay, namely, metakaolin (kaolin calcined to undergo a strong endothermic reaction associated with dehydroxylation) and kaolin clay calcined under conditions more severe than those used to convert kaolin to metakaolin, i.e., kaolin clay calcined to undergo the characteristic kaolin exothermic reaction, sometimes referred to as the spinel form of calcined kaolin. In a preferred embodiment, the microspheres containing the two forms of calcined kaolin clay are immersed in an alkaline sodium silicate solution, which is heated, preferably until the maximum obtainable amount of Y faujasite is crystallized in the microspheres.

In practice of the '902 technology, the porous microspheres in which the zeolite is crystallized are preferably prepared by forming an aqueous slurry of powdered raw (hydrated) kaolin clay (Al₂O₃:2SiO₂:2H₂O) and powdered calcined kaolin clay that has undergone the exotherm together with a minor amount of sodium silicate which acts as fluidizing agent for the slurry that is charged to a spray dryer to form microspheres and then functions to provide physical integrity to the components of the spray dried microspheres. The spray dried microspheres containing a mixture of hydrated kaolin clay and kaolin calcined to undergo the exotherm are then calcined under controlled conditions, less severe than those required to cause kaolin to undergo the exotherm, in order to dehydrate the hydrated kaolin clay portion of the microspheres and to effect its conversion into metakaolin, this resulting in microspheres containing the desired mixture of metakaolin, kaolin calcined to undergo the exotherm and sodium silicate binder. In illustrative examples of the '902 patent, about equal weights of hydrated clay and spinel are present in the spray dryer feed and the resulting calcined microspheres contain somewhat more clay that has undergone the exotherm than metakaolin. The '902 patent teaches that the calcined microspheres comprise about 30-60% by weight metakaolin and about 40-70% by weight kaolin characterized through its characteristic exotherm. A less preferred method described in the patent, involves spray drying a slurry containing a mixture of kaolin clay previously calcined to metakaolin condition and kaolin calcined to undergo the exotherm but without including any hydrated kaolin in the slurry, thus providing microspheres containing both metakaolin and kaolin calcined to undergo the exotherm directly, without calcining to convert hydrated kaolin to metakaolin.

In carrying out the invention described in the '902 patent, the microspheres composed of kaolin calcined to undergo the exotherm and metakaolin are reacted with a caustic enriched sodium silicate solution in the presence of a crystallization initiator (seeds) to convert silica and alumina in the microspheres into synthetic sodium faujasite (zeolite Y). The microspheres are separated from the sodium silicate mother liquor, ion-exchanged with rare earth, ammonium ions or both to form rare earth or various known stabilized forms of catalysts. The technology of the '902 patent provides means for achieving a desirable and unique combination of high zeolite content associated with high activity, good selectivity and thermal stability, as well as attrition-resistance.

FCC catalytic cracking generally takes place at reaction temperatures of at least about 900° F. (482° C.). The upper limit can be about 1100° F. (593.3° C.) or more. The preferred temperature range is about 950° F. to about 1050° F. (510° C. to 565.6° C.). The reaction total pressure can vary widely and can be, for example, about 5 to about 50 psig (0.34 to 3.4 atmospheres), or preferably, about 20 to about 30 psig (1.36 to 2.04 atmospheres). The maximum riser residence time is about 5 seconds, and for most charge stocks the residence time will be about 1.0 to about 2.5 seconds or less. For high molecular weight charge stocks, which are rich in aromatics, residence times of about 0.5 to about 1.5 seconds are suitable in order to crack mono- and di-aromatics and naphthenes which are the aromatics which crack most easily and which produce the highest gasoline yield, but to terminate the operation before appreciable cracking of polyaromatics occurs because these materials produce high yields of coke and C₂ and lighter gases. The length to diameter ratio of the reactor can vary widely, but the reactor should be elongated to provide a high linear velocity, such as about 25 to about 75 feet per second; and to this end a length to diameter ratio above about 20 to about 25 is suitable. The reactor can have a uniform diameter or can be provided with a continuous taper or a stepwise increase in diameter along the reaction path to maintain a nearly constant velocity along the flow path.

The weight ratio of catalyst to hydrocarbon in the feed is varied to affect variations in reactor temperature. Furthermore, the higher the temperature of the regenerated catalyst, the less catalyst is required to achieve a given reaction temperature. Therefore, a high regenerated catalyst temperature will permit low reactor densities level and thereby help to avoid back mixing in the reactor. Generally, catalyst regeneration can occur at an elevated temperature of about 1250° F. (676.6° C.) or more. Carbon-on-catalyst of the regenerated catalyst is reduced from about 0.6 to about 1.5, to a level of about 0.3 percent by weight. At usual catalyst to oil ratios, the quantity of catalyst is more than ample to achieve the desired catalytic effect and therefore if the temperature of the catalyst is high, the ratio can be safely decreased without impairing conversion. Since zeolitic catalysts, for example, are particularly sensitive to the carbon level on the catalyst, regeneration advantageously occurs at elevated temperatures in order to lower the carbon level on the catalyst to the stated range or lower. Moreover, since a prime function of the catalyst is to contribute heat to the reactor, for any given desired reactor temperature the higher the temperature of the catalyst charge, the less catalyst is required. The lower the catalyst charge rate, the lower the density of the material in the reactor. As stated, low reactor densities help to avoid back mixing.

When catalysts of the foregoing description are utilized for extended periods of time at elevated temperatures for FCC cracking, e.g., 900° F. (482° C.) to about 1100° F. (593° C.), a progressive decline in catalyst activity normally occurs as a result of coke deposition. A concurrent decline in activity, not attributable to coke deposition, may follow when the catalyst encounters, either during hydrocarbon conversion of during regeneration, any of the adverse conditions of temperature and water vapor partial pressure previously described. Deactivation by coking is normally almost completely reversible by conventional oxidative regeneration at temperatures of e.g., 750°-1100° F. When it is found that such oxidative regeneration restores less than about 70 percent of the fresh cracking activity, it is useful to remove some of the catalyst and replace the removed catalyst with fresh catalyst.

The process of this invention is directed to treating such waste catalyst to recover rare earth metal values therefrom. Further, catalyst waste formed during the catalyst manufacturing process may also be treated.

In general, the rare earth recovery process of this invention includes an acid leaching step and a separation step. The solid waste is first slurried with water at a solids level of at least about 2 wt %, preferably above about 10 wt %. A strong acid is added to the slurry to dissolve or leach the rare earth from the solids at elevated temperatures for sufficient time at pH below about 3. Alternatively, the solid waste can directly be treated with an acidic solution. After acid leaching, the next step involves separation of the dissolved rare earth from remaining solid waste and impurities in the solution.

More specifically, this invention discloses an integrated process that combines the acid leaching step and rare earth/impurities separation step in one process. The acid leaching step uses a strong acid such as HNO₃, HCl, H₂SO₄, etc. to dissolve rare earth from the FCC waste at a pH range of 0 to 3, preferably in a range of 0.5 to 2.0, at elevated temperatures of at least 40° C., usefully at 50-100° C., and preferably, 70-85° C. The treatment or contact time of the solid waste and acid solution is from 5 min to 3 hr, preferably, 30 min to 1 hr. Immediately following the acid treatment of the waste, a base, such as, but not limited to, ammonia, NH₄OH or NaOH is used to increase the pH to 4.0-6.0, preferably 5.0-5.5, to precipitate selectively Al as major impurity in the solution. The solution that contains dissolved rare earth is then separated from the solid waste precipitate by filtration. The purified rare earth in solution can be recovered by a precipitation agent such as alkali, or alkaline earth carbonate salts, ammonia, ammonium hydroxide, ammonium carbonates, ammonia/carbon dioxide gas mixtures, or alkali metal hydroxides to form rare earth carbonates or hydroxides.

An alternative process is to separate the acid leaching solution from the solid residue by filtration. The acid leaching solution contains rare earth and all dissolved impurities (mainly Al), which needs further purification. Two methods can be used to separate rare earth from the impurities. One method is to precipitate the Al impurity first as hydroxide by increasing the pH of the filtered acid leaching solution with a base such as described above to 4.0-6.0, preferably 5.0-5.5. The purified rare earth solution is separated from Al hydroxide by filtration, and then treated with a precipitation agent as disclosed above to yield rare earth carbonates or hydroxides. The other method is to precipitate rare earth as oxalates from the acid leaching solution by addition of oxalic acid or soluble oxalate salt such as ammonium oxalate. As is known in the art, rare earth oxalates will precipitate at low pH and leave Al and other impurities in solution. Rare earth oxalates are then separated from the rest of solution by filtration. Calcination of rare earth oxalates at high temperatures produces rare earth carbonates or rare earth oxides.

### Example 1

The purpose of this example is to illustrate that acid leaching removes the majority of the REO from a FCC catalyst. Sample A contains 35% zeolite Y as measured by XRD and 5.40 wt % REO.

The acid leaching was performed using 100 parts of Sample A mixed with 400 parts of 5 wt % aqueous HCl solution. The mixture was heated up to 75° C. and then kept for 2 hr under stirring, followed by filtration to collect the original acid leaching solution. The solid on the filter was then washed with 200 parts of distilled water and dried at 120° C. The ICP method was used to analyze the liquid samples, while ICP or XRF methods were used to analyze the solid samples. The analysis results of Sample A before and after acid leaching and the collected acid leaching solution are presented in Table 1. The results clearly demonstrated that >85% of REO (calculated based on solid data before and after acid leaching) was leached out from the FCC catalyst. However, a certain portion of alumina was also leached from Sample A by the acid solution.

TABLE 1

| | | Sample A | Acid |
|---|---|---|---|
| | Sample A | after acid | leaching |
| | As-is | leaching | solution |
| La₂O₃, wt % | 5.31 | 0.63 | 1.17 |
| Al₂O₃, wt % | 36.7 | 32.84 | 1.96 |
| SiO₂, wt % | 55.5 | 64.25 | 0.036 |

### Example 2

This example illustrates that the acid leaching step removes a majority of the REO from equilibrium catalysts. Sample B was an equilibrium FCC catalyst containing ˜15% zeolite Y, as determined by XRD and was obtained from a refinery. Sample B was further calcined at 593° C. for 2 hr to remove residue carbon.

The acid leaching experiment was performed using 150 parts of calcined Sample B mixed with 450 parts of distilled water. The slurry was heated up to 82° C., followed by addition of 28 parts of 68 wt % aqueous HNO₃ to reach and maintain a pH of 1.0 for 30 min under stirring. The acidic slurry was filtered to collect the original acid leaching solution. The solid on the filter was then washed with 300 parts of distilled water and dried at 120° C. The analysis results of Sample B before and after acid leaching and the acid leaching solution are presented in Table 2. The results demonstrate that >60% of REO (calculated based on solid data before and after acid leaching) was leached out from the equilibrium catalyst. However, a significant amount of impurity Al was also leached into the solution. Trace amounts of heavy metal V and Ni were also leached out.

TABLE 2

| | | Solid residue | Acid |
|---|---|---|---|
| | | after acid | leaching |
| | Sample B | leaching | solution |
| La₂O₃, wt % | 2.86 | 1.04 | 0.7048 |
| CeO₂, wt % | 0.04 | 0.02 | 0.0095 |
| Al₂O₃, wt % | 40.67 | 40.44 | 0.9444 |
| SiO₂, wt % | 52.80 | 55.48 | 0.1178 |
| Fe₂O₃, wt % | 0.83 | 0.86 | 0.0014 |
| V₂O₅, ppm | 1296 | 1190 | 36 |
| NiO, ppm | 578 | 548 | 5 |
| Total REO, wt % | 2.96 | 1.09 | 0.7143 |

### Examples 3-4

These examples illustrate that the integrated rare earth recovery process will recover high purity rare earth from treated (calcined at 593° C. for 2 hr) or non-treated (as-is) equilibrium catalyst Sample B. The carbon residue on the equilibrium catalyst does not affect the rare earth recovery efficiency.

### Example 3

150 parts of as-is Sample B was mixed with 450 parts of distilled water. The slurry was heated up to 82° C., followed by addition of 45 parts of 68 wt % aqueous HNO₃ to reach and maintain a pH of 0.5 for 30 min under stirring. Then 32 parts of 30% aqueous NH₄OH were slowly added to the acidic slurry to adjust the pH up to 5.0. The mixture was filtered and washed with 300 parts of distilled water. Both liquid and solid residue were collected and analyzed.

491 parts of the rare earth filtrate solution was heated up to 70° C. 30% aqueous NH₄OH was used to adjust the solution to a pH of about 5.7. Then 3 parts of Na₂CO₃ was added to the solution, which was stirred for 15 min. The precipitates were filtered and dried for analysis.

### Example 4

150 parts of calcined Sample B was mixed with 450 parts of distilled water. The slurry was heated up to 82° C., followed by addition of 44 parts of 68 wt % HNO₃ to reach and maintain a pH of 0.5 for 30 min under stirring. Then 34 parts of 30% NH₄OH were slowly added to the acidic slurry to adjust the pH up to 5.0. The mixture was filtered and washed with 300 parts of distilled water. Both liquid and solid residue were collected and analyzed.

450 parts of the purified rare earth solution was heated up to 160° F. 30% NH₄OH was used to adjust the solution to a pH of 5.7. Then 3 parts of Na₂CO₃ was added to the solution, which was stirred for 15 min. The precipitates were filtered and dried for analysis.

The results for both examples are listed in Table 3. Unlike the acid leaching solution in Example 2, both Ni and V as poison contaminants are not detectable (<1.0 ppm) in the recovered rare earth liquid, while Al and Si impurity concentrations are very low. The results demonstrate that the rare earth recovered in the liquid after the integrated process is high purity. This is further confirmed by the rare earth precipitation experiment using sodium carbonate as precipitating agent. Table 3 lists the analysis results of the formed rare earth carbonates that possess high purity (>97 REO wt %). The main impurity is Na₂O that mostly came from the unwashed mother liquor in the rare earth precipitates. The Al₂O₃ and SiO₂ impurities are less than 1 wt %, respectively. Most importantly, the poison metal, particularly V₂O₅ is less than the detectable limit of 20 ppm.

TABLE 3

| | | Example 3 | Example 3 | Example 4 | Example 4 |
|---|---|---|---|---|---|
| | | solid | rare earth | solid | rare earth |
| | | residue | liquid | residue | liquid |
| La₂O₃ | wt % | 1.09 | 0.5371 | 1.15 | 0.5020 |
| CeO₂ | wt % | 0.03 | 0.0079 | 0.04 | 0.0074 |
| Al₂O₃ | wt % | 41.30 | 0.0036 | 41.44 | 0.0030 |
| SiO₂ | wt % | 54.20 | 0.0005 | 54.30 | 0.0006 |
| Fe₂O₃ | wt % | 0.82 | n.d.* | 0.82 | n.d. |
| NiO | wt % | 0.05 | n.d | 0.05 | n.d |
| V₂O₅ | wt % | 0.13 | n.d | 0.13 | n.d |
| REO | wt % | 1.16 | | 1.23 | |
| Total REO | parts | 1.70 | 3.23 | 1.83 | 2.96 |
| in solid | | | | | |
| or liquid | | | | | |
| REO | % | | 65.5 | | 61.8 |
| recovered | | | | | |
| in liquid | | | | | |

Analysis of rare earth precipitates from rare earth liquid

| | | | |
|---|---|---|---|
| La₂O₃ | wt % | 96.46 | 96.72 |
| CeO₂ | wt % | 1.14 | 1.08 |
| Al₂O₃ | wt % | 0.75 | 0.66 |
| SiO₂ | wt % | 0.76 | 0.81 |
| Fe₂O₃ | wt % | 0.007 | 0.003 |
| Na₂O | wt % | 1.73 | 1.59 |
| NiO | wt % | 0.004 | 0.004 |
| V₂O₅ | wt % | <0.002 | <0.002 |
| REO | wt % | 97.4 | 97.7 |

*n.d.—not detectable (metal concentration <1.0 ppm)

### Example 5

This example illustrates that the integrated rare earth recovery process will recover high purity rare earth from an equilibrium catalyst—Sample C from BASF's Refinery Return Program.

150 parts of as-is Sample C was mixed with 450 parts of distilled water. The slurry was heated up to 82° C., followed by addition of 55 parts of 68 wt % HNO₃ to reach and maintain a pH of 0.5 for 30 min under stirring. Then 51 parts of 30% NH₄OH were slowly added to the acidic slurry to adjust pH up to 5.0. The mixture was filtered and washed with 300 parts of distilled water. Both liquid and wet solid were collected and analyzed.

500 parts of the purified rare earth solution was heated up to 160° F. 30% NH₄OH was used to adjust the solution to pH˜5.7. Then 1 part of Na₂CO₃ was added to the solution, which was stirred for 15 min. The precipitates were filtered and washed with DI water. The washed precipitates were dried for analysis.

The results are listed in Table 4. Both Ni and V as poison contaminants were under the detectable limit (<2.0 ppm) in the recovered rare earth liquid, while Al and Si impurity concentrations were very low. After rare earth precipitation from the purified rare earth solution, rare earth carbonates possessed high purity (>97 REO wt %). In this example, most of Na₂O impurity was washed away, resulting in lower Na₂O than Examples 4-5. The Al₂O₃ impurity was ca. 1 wt % and SiO₂ impurity was less than 0.1 wt %. Both V₂O₅ and NiO were below detection limit of 20 ppm.

TABLE 4

| | | | Example 5 | Example 5 |
|---|---|---|---|---|
| | | | solid | rare earth |
| | | Sample C | residue | liquid |
| La₂O₃ | wt % | 2.10 | 0.873 | 0.2252 |
| CeO₂ | wt % | 0.04 | 0.013 | 0.002 |
| Al₂O₃ | wt % | 41.7 | 42.32 | 0.0038 |
| SiO₂ | wt % | 51.9 | 53.21 | 0.0003 |
| Fe₂O₃ | wt % | 0.92 | 0.923 | n.d. |
| NiO | wt % | 0.07 | 0.069 | 0.0003 |
| V₂O₅ | wt % | 0.16 | 0.158 | n.d. |
| REO | wt % | 2.19 | 0.91 | |
| Total REO | parts | | 1.305 | 1.570 |
| in solid | | | | |
| or liquid | | | | |
| REO | % | | | 54.6 |
| recovered | | | | |
| in liquid | | | | |

Analysis of rare earth precipitates from rare earth liquid

| | | |
|---|---|---|
| La₂O₃ | wt % | 98.01 |
| CeO₂ | wt % | 0.85 |
| Al₂O₃ | wt % | 1.02 |
| SiO₂ | wt % | 0.022 |
| Fe₂O₃ | wt % | 0.003 |
| Na₂O | wt % | 0.096 |
| NiO | wt % | <0.002 |
| V₂O₅ | wt % | <0.002 |
| REO | wt % | 98.8 |

*n.d. —not detectable (metal concentration <1.0 ppm)

1. A process for recovery of rare earths from zeolite-containing FCC catalysts, comprising: (1) acid leaching by treating said FCC catalyst containing rare earths with an acid at a pH of up to 3 and elevated temperature of at least 40° C. for sufficient time to dissolve said rare earths from said FCC catalyst and form a rare earth-containing leachate; (2) precipitating aluminum and other impurities selected from Fe, Ni, V and mixtures thereof from said leachate so as to leave said rare earths in a purified solution by increasing the pH of said leachate to 4.0 to 6.0 with a base to precipitate said aluminum and said other impurities and (3) recovering said rare earths.

2. A process according to claim 1, wherein said zeolite-containing FCC catalyst contains a matrix comprising aluminum.

3. (canceled)

4. A process according to claim 1, wherein said acid leaching is conducted at a pH of between 0.5-1.5.

5. (canceled)

6. A process according to claim 1, wherein said rare earths are removed from said purified solution by treating said purified solution with a precipitating agent, selected from a carbonate salt or hydroxide to precipitate rare earth carbonates or rare earth hydroxides from said purified solution.

7. A process according to claim 1, wherein said rare earths are recovered as rare earth carbonates or hydroxides.

8. A process according to claim 4, wherein the acid is HNO₃ or HCl.

9. A process according to claim 1, wherein the base is ammonia, ammonium hydroxide or NaOH.

10. (canceled)

11. (canceled)

12. (canceled)

13. A process according to claim 6, wherein the precipitating agent is Na₂CO₃, NaHCO₃, ammonia, NH₄OH, (NH₄)₂CO₃, NH₄HCO₃, NH₃/CO₂ gas mixture and NaOH.

14. A process according to claim 1, wherein said FCC catalyst is an FCC equilibrium catalyst removed from an FCC reactor or catalyst waste from manufacturing.

15. A process according to claim 1, wherein said FCC catalyst contains 0.5-25 percent by weight rare earth based on rare earth oxides.

16. A process according to claim 1, wherein said zeolite-containing FCC catalyst comprises a zeolite incorporated within a silica and alumina containing matrix.

17. A process according to claim 1, wherein said zeolite-containing FCC catalyst comprises zeolite formed in-situ from a kaolin-containing microsphere.

18. (canceled)

19. A process according to claim 1, wherein said sufficient time is from 5 minutes to 3 hours.

20. A process according to claim 19, wherein said elevated temperature is from 50-100° C. and said sufficient time is from 30 minutes to 1 hour.
